(19) United States
(12) Patent Application Publication
(10) Pub. No.: US 2020/0143744 A1
(43) Pub. Date: May 7, 2020

(54) MOBILE TERMINAL

(71) Applicant: LG ELECTRONICS INC., Seoul (KR)

(72) Inventors: Minhyeok KIM, Seoul (KR); Yongchul SHIN, Seoul (KR); Seungjun CHOI, Seoul (KR)

(73) Assignee: LG ELECTRONICS INC., Seoul (KR)

(21) Appl. No.: 16/509,751

(22) Filed: Jul. 12, 2019

(30) Foreign Application Priority Data
Nov. 6, 2018 (KR) 10-2018-0135119

(51) Int. Cl. G09G 3/3258; H04M 1/725

(52) U.S. Cl. CPC G09G 3/3258; H04M 1/72519; G09G 2310/0243; G09G 2320/0626; G09G 2320/046

(57) ABSTRACT

A mobile terminal including a display unit including a plurality of pixels aligned in a matrix; and a controller configured to display a screen on the display unit, display a fixed object at a specific location on the screen for a preset time period or more, and drive an adjacent pixel located adjacent to the fixed object at compensated level while pixels for the fixed object are not driven.

### CROSS-REFERENCE TO RELATED APPLICATION

Pursuant to 35 U.S.C. § 119(a), this application claims the benefit of an earlier filing date and priority to Korean Application No. 10-2018-0135119 filed in the Republic of Korea on Nov. 6, 2018, the entire contents of which is hereby incorporated by reference in its entirety.

### BACKGROUND OF THE DISCLOSURE

### Field of the Disclosure

Embodiments of the present disclosure relate to a mobile terminal having a compensation function for secure the durability of an OLED display on which burn-in occurs with time-worn of a specific pixel.

### Background of the Disclosure

Terminals may be generally classified as mobile/portable terminals or stationary terminals. Mobile terminals may also be classified as handheld terminals or vehicle mounted terminals.

Mobile terminals have become increasingly more functional. Examples of such functions include data and voice communications, capturing images and video via a camera, recording audio, playing music files via a speaker system, and displaying images and video on a display. Some mobile terminals include additional functionality which supports game playing, while other terminals are configured as multimedia players. More recently, mobile terminals have been configured to receive broadcast and multicast signals which permit viewing of content such as videos and television programs.

As such functions become more diversified, the mobile terminal can support more complicated functions such as capturing images or video, reproducing music or video files, playing games, receiving broadcast signals, and the like. By comprehensively and collectively implementing such functions, the mobile terminal may be embodied in the form of a multimedia player or device.

As functioning as multimedia device more and more, a display has not only a displaying function but also an input function. Accordingly, the size of such a display becomes large and the display occupies a larger area on a front surface of a mobile terminal. In contrast to the enlarged size of the display unit, the mobile terminal is required to have a lighter and slimmer design and the display provided in the mobile terminal then becomes thinner.

Liquid Crystal Display (LCD) configured to receive lights via a backlight unit and emit colors according to information about an image is usually used as the conventional display unit. However, an OLED display including Organic Light Emitting Diode (OLED) configured to emit light from pixels without an auxiliary backlight unit may be used. Similar to the characteristic that pixels emit light spontaneously like LED, the conventional LED uses a semiconductor or metallic material but OLED uses an organic material, in other words, a non-metallic carbon compound as a luminescent element. Accordingly, OLED may be realized into a slim-small designed device.

The OLED includes an organic compound layer (HIL, HTL, EML, ETL, EIL) formed between an anode pole and a cathode pole. The organic compound layer includes a hole injection layer (HIL), a hole transport layer (HTL), an emission layer (EML), an electron transport layer (ETL) and an electron injection layer (EIL). Once a drive voltage is applied to the anode pole and the cathode pole, the hole penetrating HTL and the electron penetrating ETL are moved to EML and an exciton is then formed. Accordingly, EML emits a visible ray.

An OLED display device includes the pixels having OLEDs which are aligned in a matrix and controls the brightness of the pixels selected by a scan-pulse based on gradation of data. The pixels of an active-matrix OLED device may include OLEDs, a data line (DL) and a gate line (GL) that cross each other, a switch TFT (SW), a drive TFT (DR) and a storage capacitor (Cst). The switch TFT (SW) and the drive TFT (DR) may be realized as P-type MOS-FET.

The switch TFT (SW) is turned on in response to a scan pulse transmitted from the gate line (GL) and conducts a current path between its source electrode and a drain electrode. The switch TFT (SW) applies a data voltage of the data line (DL) to a gate electrode of the drive TFT (DR) and the storage capacitor (Cst) during the turned-on period. The drive TFT (DR) controls the current flowing to OLED according to a voltage difference (Vgs) between its gate electrode and its source electrode. The storage capacitor (Cst) maintains a gate potential of the drive TFT (DR) during one frame uniformly.

A deviation of electrical characteristics of the drive TFT and a deviation of high-potential drive voltages according to locations happen to generate brightness non-uniformity among the pixels. However, the largest cause of the brightness non-uniformity is a degradation deviation of the OLEDs. The degradation deviation is caused by different driving time periods or degrees among the pixels when the display is driven for a long time period. If the degradation deviation becomes severe, image fixation, in other words, a residual image remains only to shorten the life span of the device disadvantageously. Efforts are ongoing to support and increase the functionality of mobile terminals. Such efforts include software and hardware improvements, as well as changes and improvements in the structural components.

### SUMMARY OF THE DISCLOSURE

Accordingly, an object of the present invention is to address the above-noted and other problems and provide a mobile terminal having a compensation function configured to be implemented to minimize the degradation caused in an OLED display.

Embodiments of the present disclosure may provide a mobile terminal comprising a body; a display unit provided in a front surface of the body and comprising a plurality of pixels aligned in a matrix; and a controller configured to control an image output on the display unit, wherein the controller implements a compensation function configured to output a fixed object at a specific location for a preset time period or more, and the controller implements a compensation function configured to drive a pixel located adjacent to the fixed object.

The controller may implement the compensation function in a time period while the fixed object is not output.

The compensation function may gradually reduce the drive times or frequencies of the pixels along a direction that is farther from a neighboring area of the fixed object.

The fixed object may comprise at least one of a fixed icon, a menu button, a former page button, a home button, a search box and a current-state display icon.

The controller may set the implementation time of the compensation function in proportion to the time period while the fixed object is output on the display unit.

The display unit may output a screen for a preset time period or more, the screen comprising a first area outputting an image and a second area outputting not image, and the compensation function may further drive a pixel of an area of the second area that is near the first area.

The plurality of the pixels may comprise a sensing transistor configured to sense variation of a voltage or current value applied to each of the pixels, and the controller may compensate the voltage value applied to the pixel of which the voltage or current value is varied based on the result of the sensing performed by the sensing transistor and controls the pixel having the compensated voltage value to emit the light having the same brightness as the neighboring pixels.

The plurality of the pixels may comprise a sensing transistor configured to configured to sense variation of a voltage or current value applied to each of the pixels, and the controller may implement the compensation function for the neighboring pixels of the pixel of which of which the voltage or current value is varied based on the result of the sensing performed by the sensing transistor.

The controller may set a pixel for compensating the compensation function based on image information about the fixed object.

The controller may comprise a display drive IC coupled to one side of the display unit.

According to the embodiments of the present disclosure, the mobile terminal may prevent the residual image caused by the OLED degradation and expand the life span of the display unit.

Furthermore, the problem of the residual image remaining on the screen may be prevented by controlling the neighboring pixels of the deteriorated pixel as well as controlling the degradation of the deteriorated pixel in the circuit.

Further scope of applicability of the present invention will become apparent from the detailed description given hereinafter. However, it should be understood that the detailed description and specific examples, while indicating preferred embodiments of the invention, are given by illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below and the accompanying drawings, which are given by illustration only, and thus are not limitative of the present invention, and wherein:

FIG. 1A is a block diagram of a mobile terminal in accordance with the present disclosure.

FIGS. 1B and 1C are conceptual views of one example of the mobile terminal, viewed from different directions;

FIG. 2 is a diagram to describe an OLED display unit in accordance with one embodiment of the present disclosure;

FIG. 3 is a diagram illustrating one example of connection between a sensing line and a pixel;

FIG. 4 is a diagram illustrating one example of a pixel array and a data driver IC;

FIG. 5 is a diagram illustrating one example of a screen that is output on the display of the present disclosure and FIG. 6 is a flow chart illustrating an execution process of a compensation function provided in the mobile terminal; and

FIG. 7 is a diagram to describe the implementation of the compensation function.

### DESCRIPTION OF SPECIFIC EMBODIMENTS

Description will now be given in detail according to exemplary embodiments disclosed herein, with reference to the accompanying drawings. For the sake of brief description with reference to the drawings, the same or equivalent components may be provided with the same reference numbers, and description thereof will not be repeated. In general, a suffix such as “module” and “unit” may be used to refer to elements or components. Use of such a suffix herein is merely intended to facilitate description of the specification, and the suffix itself is not intended to give any special meaning or function. In the present disclosure, that which is well-known to one of ordinary skill in the relevant art has generally been omitted for the sake of brevity. The accompanying drawings are used to help easily understand various technical features and it should be understood that the embodiments presented herein are not limited by the accompanying drawings. As such, the present disclosure should be construed to extend to any alterations, equivalents and substitutes in addition to those which are particularly set out in the accompanying drawings.

Although the terms first, second, etc. may be used herein to describe various elements, these elements should not be limited by these terms. These terms are generally only used to distinguish one element from another.

When an element is referred to as being “connected with” another element, the element can be directly connected with the other element or intervening elements may also be present. In contrast, when an element is referred to as being “directly connected with” another element, there are no intervening elements present.

A singular representation may include a plural representation unless it represents a definitely different meaning from the context. Terms such as “include” or “has” are used herein and should be understood that they are intended to indicate an existence of several components, functions or steps, disclosed in the specification, and it is also understood that greater or fewer components, functions, or steps may likewise be utilized.

Mobile terminals presented herein may be implemented using a variety of different types of terminals. Examples of such terminals include cellular phones, smart phones, user equipment, laptop computers, digital broadcast terminals, personal digital assistants (PDAs), portable multimedia players (PMPs), navigators, portable computers (PCs), slate PCs, tablet PCs, ultra books, wearable devices (for example, smart watches, smart glasses, head mounted displays (HMDs)), and the like.

By way of non-limiting example only, further description will be made with reference to particular types of mobile terminals. However, such teachings apply equally to other types of terminals, such as those types noted above. In addition, these teachings may also be applied to stationary terminals such as digital TV, desktop computers, and the like.

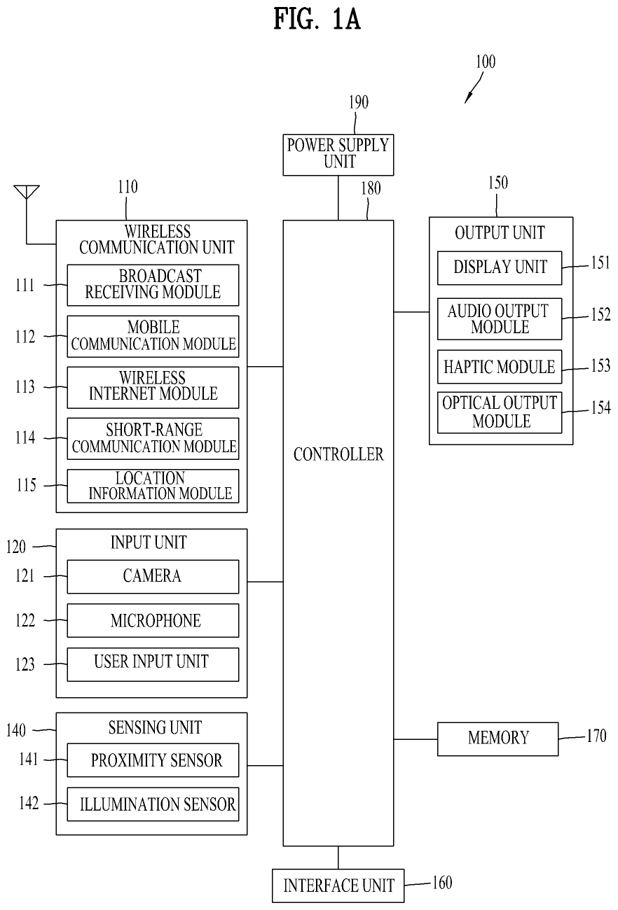

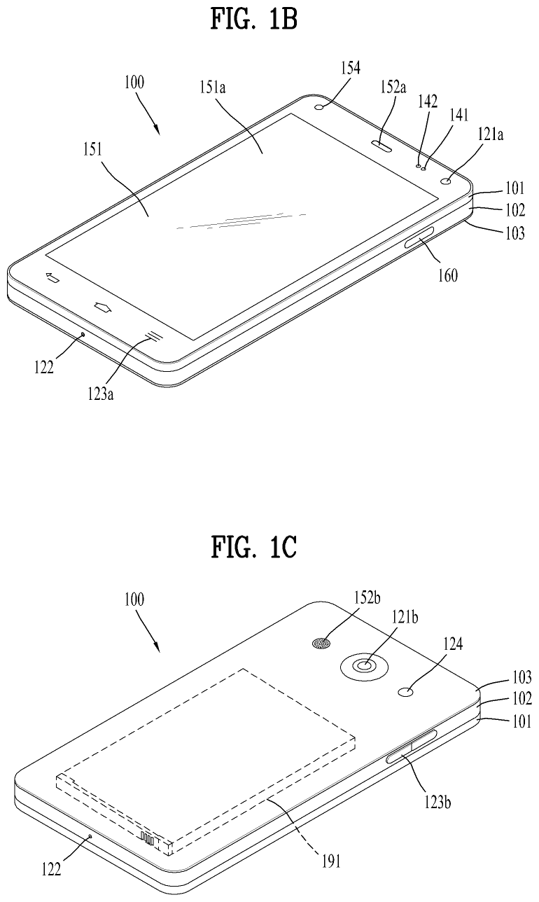

Reference is now made to FIGS. 1A-1C, where FIG. 1A is a block diagram of a mobile terminal in accordance with the present disclosure, and FIGS. 1B and 1C are conceptual views of one example of the mobile terminal, viewed from different directions. The mobile terminal 100 is shown having components such as a wireless communication unit 110, an input unit 120, a sensing unit 140, an output unit 150, an interface unit 160, a memory 170, a controller 180, and a power supply unit 190. Implementing all of the illustrated components in The FIG. 1A is not a requirement, and that greater or fewer components may alternatively be implemented.

More specifically, the wireless communication unit 110 typically includes one or more modules which permit communications such as wireless communications between the mobile terminal 100 and a wireless communication system, communications between the mobile terminal 100 and another mobile terminal, communications between the mobile terminal 100 and an external server. Further, the wireless communication unit 110 typically includes one or more modules which connect the mobile terminal 100 to one or more networks.

To facilitate such communications, the wireless communication unit 110 includes one or more of a broadcast receiving module 111, a mobile communication module 112, a wireless Internet module 113, a short-range communication module 114, and a location information module 115.

The input unit 120 includes a camera 121 for obtaining images or video, a microphone 122, which is one type of audio input device for inputting an audio signal, and a user input unit 123 (for example, a touch key, a push key, a mechanical key, a soft key, and the like) for allowing a user to input information. Data (for example, audio, video, image, and the like) is obtained by the input unit 120 and may be analyzed and processed by controller 180 according to device parameters, user commands, and combinations thereof.

The sensing unit 140 is typically implemented using one or more sensors configured to sense internal information of the mobile terminal, the surrounding environment of the mobile terminal, user information, and the like. For example, the sensing unit 140 may alternatively or additionally include other types of sensors or devices, such as a proximity sensor 141 and an illumination sensor 142, a touch sensor, an acceleration sensor, a magnetic sensor, a G-sensor, a gyroscope sensor, a motion sensor, an RGB sensor, an infrared (IR) sensor, a finger scan sensor, a ultrasonic sensor, an optical sensor (for example, camera 121), a microphone 122, a battery gauge, an environment sensor (for example, a barometer, a hygrometer, a thermometer, a radiation detection sensor, a thermal sensor, and a gas sensor, among others), and a chemical sensor (for example, an electronic nose, a health care sensor, a biometric sensor, and the like), to name a few. The mobile terminal 100 may be configured to utilize information obtained from sensing unit 140, and in particular, information obtained from one or more sensors of the sensing unit 140, and combinations thereof.

The output unit 150 is typically configured to output various types of information, such as audio, video, tactile output, and the like. The output unit 150 is shown having a display unit 151, an audio output module 152, a haptic module 153, and an optical output module 154. The display unit 151 may have an inter-layered structure or an integrated structure with a touch sensor in order to facilitate a touch screen. The touch screen may provide an output interface between the mobile terminal 100 and a user, as well as function as the user input unit 123 which provides an input interface between the mobile terminal 100 and the user.

The interface unit 160 serves as an interface with various types of external devices that can be coupled to the mobile terminal 100. The interface unit 160, for example, may include any of wired or wireless ports, external power supply ports, wired or wireless data ports, memory card ports, ports for connecting a device having an identification module, audio input/output (I/O) ports, video I/O ports, earphone ports, and the like. In some cases, the mobile terminal 100 may perform assorted control functions associated with a connected external device, in response to the external device being connected to the interface unit 160.

The memory 170 is typically implemented to store data to support various functions or features of the mobile terminal 100. For instance, the memory 170 may be configured to store application programs executed in the mobile terminal 100, data or instructions for operations of the mobile terminal 100, and the like. Some of these application programs may be downloaded from an external server via wireless communication. Other application programs may be installed within the mobile terminal 100 at time of manufacturing or shipping, which is typically the case for basic functions of the mobile terminal 100 (for example, receiving a call, placing a call, receiving a message, sending a message, and the like). It is common for application programs to be stored in the memory 170, installed in the mobile terminal 100, and executed by the controller 180 to perform an operation (or function) for the mobile terminal 100.

The controller 180 typically functions to control overall operation of the mobile terminal 100, in addition to the operations associated with the application programs. The controller 180 can provide or process information or functions appropriate for a user by processing signals, data, information and the like, which are input or output, or activating application programs stored in the memory 170.

To drive the application programs stored in the memory 170, the controller 180 can be implemented to control a predetermined number of the components mentioned above in reference with FIG. 1A. Moreover, the controller 180 can be implemented to combinedly operate two or more of the components provided in the mobile terminal 100 to drive the application programs.

The power supply unit 190 can be configured to receive external power or provide internal power in order to supply appropriate power required for operating elements and components included in the mobile terminal 100. The power supply unit 190 may include a battery, and the battery may be configured to be embedded in the terminal body, or configured to be detachable from the terminal body.

Some or more of the components may be operated cooperatively to embody an operation, control or a control method of the mobile terminal in accordance with embodiments of the present disclosure. Also, the operation, control or control method of the mobile terminal may be realized on the mobile terminal by driving of one or more application problems stored in the memory 170.

Hereinafter, referring to FIG. 1A, the components mentioned above will be described in detail before describing the various embodiments which are realized by the mobile terminal 100 in accordance with the present disclosure. Regarding the wireless communication unit 110, the broadcast receiving module 111 is typically configured to receive a broadcast signal and/or broadcast associated information from an external broadcast managing entity via a broadcast channel. The broadcast channel may include a satellite channel, a terrestrial channel, or both. In some embodiments, two or more broadcast receiving modules 111 may be utilized to facilitate simultaneously receiving of two or more broadcast channels, or to support switching among broadcast channels.

The mobile communication module 112 can transmit and/or receive wireless signals to and from one or more network entities. Typical examples of a network entity include a base station, an external mobile terminal, a server, and the like. Such network entities form part of a mobile communication network, which is constructed according to technical standards or communication methods for mobile communications (for example, Global System for Mobile Communication (GSM), Code Division Multi Access (CDMA), CDMA2000 (Code Division Multi Access 2000), EV-DO (Enhanced Voice-Data Optimized or Enhanced Voice-Data Only), Wideband CDMA (WCDMA), High Speed Downlink Packet access (HSDPA), HSUPA (High Speed Uplink Packet Access), Long Term Evolution (LTE), LTE-A (Long Term Evolution-Advanced), and the like).

Examples of wireless signals transmitted and/or received via the mobile communication module 112 include audio call signals, video (telephony) call signals, or various formats of data to support communication of text and multimedia messages. The wireless Internet module 113 is configured to facilitate wireless Internet access. This module may be internally or externally coupled to the mobile terminal 100. The wireless Internet module 113 may transmit and/or receive wireless signals via communication networks according to wireless Internet technologies.

Examples of such wireless Internet access include Wireless LAN (WLAN), Wireless Fidelity (Wi-Fi), Wi-Fi Direct, Digital Living Network Alliance (DLNA), Wireless Broadband (WiBro), Worldwide Interoperability for Microwave Access (WiMAX), High Speed Downlink Packet Access (HSDPA), HSUPA (High Speed Uplink Packet Access), Long Term Evolution (LTE), LTE-A (Long Term Evolution-Advanced), and the like. The wireless Internet module 113 may transmit/receive data according to one or more of such wireless Internet technologies, and other Internet technologies as well.

In some embodiments, when the wireless Internet access is implemented according to, for example, WiBro, HSDPA, HSUPA, GSM, CDMA, WCDMA, LTE, LTE-A and the like, as part of a mobile communication network, the wireless Internet module 113 performs such wireless Internet access. As such, the Internet module 113 may cooperate with, or function as, the mobile communication module 112.

The short-range communication module 114 is configured to facilitate short-range communications. Suitable technologies for implementing such short-range communications include BLUETOOTH™, Radio Frequency IDentification (RFID), Infrared Data Association (IrDA), Ultra-WideBand (UWB), ZigBee, Near Field Communication (NFC), Wireless-Fidelity (Wi-Fi), Wi-Fi Direct, Wireless USB (Wireless Universal Serial Bus), and the like. The short-range communication module 114 in general supports wireless communications between the mobile terminal 100 and a wireless communication system, communications between the mobile terminal 100 and another mobile terminal 100, or communications between the mobile terminal and a network where another mobile terminal 100 (or an external server) is located, via wireless area networks. One example of the wireless area networks is a wireless personal area networks.

In some embodiments, another mobile terminal (which may be configured similarly to mobile terminal 100) may be a wearable device, for example, a smart watch, a smart glass or a head mounted display (HMD), which can exchange data with the mobile terminal 100 (or otherwise cooperate with the mobile terminal 100). The short-range communication module 114 may sense or recognize the wearable device, and permit communication between the wearable device and the mobile terminal 100. In addition, when the sensed wearable device is a device which is authenticated to communicate with the mobile terminal 100, the controller 180, for example, may cause transmission of data processed in the mobile terminal 100 to the wearable device via the short-range communication module 114. Hence, a user of the wearable device may use the data processed in the mobile terminal 100 on the wearable device. For example, when a call is received in the mobile terminal 100, the user may answer the call using the wearable device. Also, when a message is received in the mobile terminal 100, the user can check the received message using the wearable device.

The location information module 115 is generally configured to detect, calculate, derive or otherwise identify a position of the mobile terminal. As an example, the location information module 115 includes a Global Position System (GPS) module, a Wi-Fi module, or both. If desired, the location information module 115 may alternatively or additionally function with any of the other modules of the wireless communication unit 110 to obtain data related to the position of the mobile terminal. As one example, when the mobile terminal uses a GPS module, a position of the mobile terminal may be acquired using a signal sent from a GPS satellite. As another example, when the mobile terminal uses the Wi-Fi module, a position of the mobile terminal can be acquired based on information related to a wireless access point (AP) which transmits or receives a wireless signal to or from the Wi-Fi module.

The input unit 120 may be configured to permit various types of input to the mobile terminal 120. Examples of such input include audio, image, video, data, and user input. Image and video input is often obtained using one or more cameras 121. Such cameras 121 may process image frames of still pictures or video obtained by image sensors in a video or image capture mode. The processed image frames can be displayed on the display unit 151 or stored in memory 170. In some cases, the cameras 121 may be arranged in a matrix configuration to permit a plurality of images having various angles or focal points to be input to the mobile terminal 100. As another example, the cameras 121 may be located in a stereoscopic arrangement to acquire left and right images for implementing a stereoscopic image.

The microphone 122 is generally implemented to permit audio input to the mobile terminal 100. The audio input can be processed in various manners according to a function being executed in the mobile terminal 100. If desired, the microphone 122 may include assorted noise removing algorithms to remove unwanted noise generated in the course of receiving the external audio.

The user input unit 123 is a component that permits input by a user. Such user input may enable the controller 180 to control operation of the mobile terminal 100. The user input unit 123 may include one or more of a mechanical input element (for example, a key, a button located on a front and/or rear surface or a side surface of the mobile terminal 100, a dome switch, a jog wheel, a jog switch, and the like), or a touch-sensitive input, among others. As one example, the touch-sensitive input may be a virtual key or a soft key, which is displayed on a touch screen through software processing, or a touch key which is located on the mobile terminal at a location that is other than the touch screen. Further, the virtual key or the visual key may be displayed on the touch screen in various shapes, for example, graphic, text, icon, video, or a combination thereof.

The sensing unit 140 is generally configured to sense one or more of internal information of the mobile terminal, surrounding environment information of the mobile terminal, user information, or the like. The controller 180 generally cooperates with the sensing unit 140 to control operation of the mobile terminal 100 or execute data processing, a function or an operation associated with an application program installed in the mobile terminal based on the sensing provided by the sensing unit 140. The sensing unit 140 may be implemented using any of a variety of sensors, some of which will now be described in more detail.

The proximity sensor 141 may include a sensor to sense presence or absence of an object approaching a surface, or an object located near a surface, by using an electromagnetic field, infrared rays, or the like without a mechanical contact. The proximity sensor 141 may be arranged at an inner region of the mobile terminal covered by the touch screen, or near the touch screen.

The proximity sensor 141, for example, may include any of a transmissive type photoelectric sensor, a direct reflective type photoelectric sensor, a mirror reflective type photoelectric sensor, a high-frequency oscillation proximity sensor, a capacitance type proximity sensor, a magnetic type proximity sensor, an infrared rays proximity sensor, and the like. When the touch screen is implemented as a capacitance type, the proximity sensor 141 can sense proximity of a pointer relative to the touch screen by changes of an electromagnetic field, which is responsive to an approach of an object with conductivity. In this instance, the touch screen (touch sensor) may also be categorized as a proximity sensor.

The term “proximity touch” will often be referred to herein to denote the scenario in which a pointer is positioned to be proximate to the touch screen without contacting the touch screen. The term “contact touch” will often be referred to herein to denote the scenario in which a pointer makes physical contact with the touch screen. For the position corresponding to the proximity touch of the pointer relative to the touch screen, such position will correspond to a position where the pointer is perpendicular to the touch screen. The proximity sensor 141 may sense proximity touch, and proximity touch patterns (for example, distance, direction, speed, time, position, moving status, and the like). In general, controller 180 processes data corresponding to proximity touches and proximity touch patterns sensed by the proximity sensor 141, and cause output of visual information on the touch screen. In addition, the controller 180 can control the mobile terminal 100 to execute different operations or process different data according to whether a touch with respect to a point on the touch screen is either a proximity touch or a contact touch.

A touch sensor can sense a touch applied to the touch screen, such as display unit 151, using any of a variety of touch methods. Examples of such touch methods include a resistive type, a capacitive type, an infrared type, and a magnetic field type, among others. As one example, the touch sensor may be configured to convert changes of pressure applied to a specific part of the display unit 151, or convert capacitance occurring at a specific part of the display unit 151, into electric input signals. The touch sensor may also be configured to sense not only a touched position and a touched area, but also touch pressure and/or touch capacitance. A touch object is generally used to apply a touch input to the touch sensor. Examples of typical touch objects include a finger, a touch pen, a stylus pen, a pointer, or the like.

When a touch input is sensed by a touch sensor, corresponding signals may be transmitted to a touch controller. The touch controller may process the received signals, and then transmit corresponding data to the controller 180. Accordingly, the controller 180 can sense which region of the display unit 151 has been touched. Here, the touch controller may be a component separate from the controller 180, the controller 180, and combinations thereof.

In some embodiments, the controller 180 can execute the same or different controls according to a type of touch object that touches the touch screen or a touch key provided in addition to the touch screen. Whether to execute the same or different control according to the object which provides a touch input may be decided based on a current operating state of the mobile terminal 100 or a currently executed application program, for example.

The touch sensor and the proximity sensor may be implemented individually, or in combination, to sense various types of touches. Such touches include a short (or tap) touch, a long touch, a multi-touch, a drag touch, a flick touch, a pinch-in touch, a pinch-out touch, a swipe touch, a hovering touch, and the like.

If desired, an ultrasonic sensor may be implemented to recognize position information relating to a touch object using ultrasonic waves. The controller 180, for example, may calculate a position of a wave generation source based on information sensed by an illumination sensor and a plurality of ultrasonic sensors. Since light is much faster than ultrasonic waves, the time for which the light reaches the optical sensor is much shorter than the time for which the ultrasonic wave reaches the ultrasonic sensor. The position of the wave generation source may be calculated using this fact. For instance, the position of the wave generation source may be calculated using the time difference from the time that the ultrasonic wave reaches the sensor based on the light as a reference signal.

The camera 121 typically includes at least one a camera sensor (CCD, CMOS etc.), a photo sensor (or image sensors), and a laser sensor. Implementing the camera 121 with a laser sensor may allow detection of a touch of a physical object with respect to a 3D stereoscopic image. The photo sensor may be laminated on, or overlapped with, the display device. The photo sensor may be configured to scan movement of the physical object in proximity to the touch screen. In more detail, the photo sensor may include photo diodes and transistors at rows and columns to scan content received at the photo sensor using an electrical signal which changes according to the quantity of applied light. Namely, the photo sensor may calculate the coordinates of the physical object according to variation of light to thus obtain position information of the physical object.

The display unit 151 is generally configured to output information processed in the mobile terminal 100. For example, the display unit 151 may display execution screen information of an application program executing at the mobile terminal 100 or user interface (UI) and graphic user interface (GUI) information in response to the execution screen information.

In some embodiments, the display unit 151 may be implemented as a stereoscopic display unit for displaying stereoscopic images. A typical stereoscopic display unit may employ a stereoscopic display scheme such as a stereoscopic scheme (a glass scheme), an auto-stereoscopic scheme (glassless scheme), a projection scheme (holographic scheme), or the like.

The audio output module 152 is generally configured to output audio data. Such audio data may be obtained from any of a number of different sources, such that the audio data may be received from the wireless communication unit 110 or may have been stored in the memory 170. The audio data may be output during modes such as a signal reception mode, a call mode, a record mode, a voice recognition mode, a broadcast reception mode, and the like. The audio output module 152 can provide audible output related to a particular function (e.g., a call signal reception sound, a message reception sound, etc.) performed by the mobile terminal 100. The audio output module 152 may also be implemented as a receiver, a speaker, a buzzer, or the like.

A haptic module 153 can be configured to generate various tactile effects that a user feels, perceive, or otherwise experience. A typical example of a tactile effect generated by the haptic module 153 is vibration. The strength, pattern and the like of the vibration generated by the haptic module 153 can be controlled by user selection or setting by the controller. For example, the haptic module 153 may output different vibrations in a combining manner or a sequential manner.

Besides vibration, the haptic module 153 can generate various other tactile effects, including an effect by stimulation such as a pin arrangement vertically moving to contact skin, a spray force or suction force of air through a jet orifice or a suction opening, a touch to the skin, a contact of an electrode, electrostatic force, an effect by reproducing the sense of cold and warmth using an element that can absorb or generate heat, and the like.

The haptic module 153 can also be implemented to allow the user to feel a tactile effect through a muscle sensation such as the user's fingers or arm, as well as transferring the tactile effect through direct contact. Two or more haptic modules 153 may be provided according to the particular configuration of the mobile terminal 100.

An optical output module 154 can output a signal for indicating an event generation using light of a light source. Examples of events generated in the mobile terminal 100 may include message reception, call signal reception, a missed call, an alarm, a schedule notice, an email reception, information reception through an application, and the like.

A signal output by the optical output module 154 may be implemented so the mobile terminal emits monochromatic light or light with a plurality of colors. The signal output may be terminated as the mobile terminal senses that a user has checked the generated event, for example.

The interface unit 160 serves as an interface for external devices to be connected with the mobile terminal 100. For example, the interface unit 160 can receive data transmitted from an external device, receive power to transfer to elements and components within the mobile terminal 100, or transmit internal data of the mobile terminal 100 to such external device. The interface unit 160 may include wired or wireless headset ports, external power supply ports, wired or wireless data ports, memory card ports, ports for connecting a device having an identification module, audio input/output (I/O) ports, video I/O ports, earphone ports, or the like.

The identification module may be a chip that stores various information for authenticating authority of using the mobile terminal 100 and may include a user identity module (UIM), a subscriber identity module (SIM), a universal subscriber identity module (USIM), and the like. In addition, the device having the identification module (also referred to herein as an “identifying device”) may take the form of a smart card. Accordingly, the identifying device can be connected with the terminal 100 via the interface unit 160.

When the mobile terminal 100 is connected with an external cradle, the interface unit 160 can serve as a passage to allow power from the cradle to be supplied to the mobile terminal 100 or may serve as a passage to allow various command signals input by the user from the cradle to be transferred to the mobile terminal there through. Various command signals or power input from the cradle may operate as signals for recognizing that the mobile terminal is properly mounted on the cradle.

The memory 170 can store programs to support operations of the controller 180 and store input/output data (for example, phonebook, messages, still images, videos, etc.). The memory 170 may store data related to various patterns of vibrations and audio which are output in response to touch inputs on the touch screen.

The memory 170 may include one or more types of storage mediums including a Flash memory, a hard disk, a solid state disk, a silicon disk, a multimedia card micro type, a card-type memory (e.g., SD or DX memory, etc.), a Random Access Memory (RAM), a Static Random Access Memory (SRAM), a Read-Only Memory (ROM), an Electrically Erasable Programmable Read-Only Memory (EEPROM), a Programmable Read-Only memory (PROM), a magnetic memory, a magnetic disk, an optical disk, and the like. The mobile terminal 100 may also be operated in relation to a network storage device that performs the storage function of the memory 170 over a network, such as the Internet.

The controller 180 can typically control the general operations of the mobile terminal 100. For example, the controller 180 can set or release a lock state for restricting a user from inputting a control command with respect to applications when a status of the mobile terminal meets a preset condition.

The controller 180 can also perform the controlling and processing associated with voice calls, data communications, video calls, and the like, or perform pattern recognition processing to recognize a handwriting input or a picture drawing input performed on the touch screen as characters or images, respectively. In addition, the controller 180 can control one or a combination of those components in order to implement various exemplary embodiments disclosed herein.

The power supply unit 190 may be provided with the power supplied by an external power source and the power supplied therein under the control of the controller 180 so as to supply the needed power to each of the components. The power supply unit 190 may include a battery. The battery may be a built-in type which is rechargeable and detachably loaded in the terminal to be charged.

The power supply unit 190 may include a connection port. The connection port may be configured as one example of the interface unit 160 to which an external charger for supplying power to recharge the battery is electrically connected. As another example, the power supply unit 190 may be configured to recharge the battery in a wireless manner without use of the connection port. In this example, the power supply unit 190 can receive power, transferred from an external wireless power transmitter, using at least one of an inductive coupling method which is based on magnetic induction or a magnetic resonance coupling method which is based on electromagnetic resonance. Various embodiments described herein may be implemented in a computer-readable medium, a machine-readable medium, or similar medium using, for example, software, hardware, or any combination thereof.

Referring now to FIGS. 1B and 1C, the mobile terminal 100 is described with reference to a bar-type terminal body. However, the mobile terminal 100 may alternatively be implemented in any of a variety of different configurations. Examples of such configurations include watch-type, clip-type, glasses-type, or as a folder-type, flip-type, slide-type, swing-type, and swivel-type in which two and more bodies are combined with each other in a relatively movable manner, and combinations thereof. Discussion herein will often relate to a particular type of mobile terminal (for example, bar-type, watch-type, glasses-type, and the like). However, such teachings with regard to a particular type of mobile terminal will generally apply to other types of mobile terminals as well.

The mobile terminal 100 will generally include a case (for example, frame, housing, cover, and the like) forming the appearance of the terminal. In this embodiment, the case is formed using a front case 101 and a rear case 102. Various electronic components are incorporated into a space formed between the front case 101 and the rear case 102. At least one middle case may be additionally positioned between the front case 101 and the rear case 102.

The display unit 151 is shown located on the front side of the terminal body to output information. As illustrated, a window 151a of the display unit 151 may be mounted to the front case 101 to form the front surface of the terminal body together with the front case 101. In some embodiments, electronic components may also be mounted to the rear case 102. Examples of such electronic components include a detachable battery 191, an identification module, a memory card, and the like. Rear cover 103 is shown covering the electronic components, and this cover may be detachably coupled to the rear case 102. Therefore, when the rear cover 103 is detached from the rear case 102, the electronic components mounted to the rear case 102 are externally exposed.

As illustrated, when the rear cover 103 is coupled to the rear case 102, a side surface of the rear case 102 is partially exposed. In some cases, upon the coupling, the rear case 102 may also be completely shielded by the rear cover 103. In some embodiments, the rear cover 103 may include an opening for externally exposing a camera 121b or an audio output module 152b.

The cases 101, 102, 103 may be formed by injection-molding synthetic resin or may be formed of a metal, for example, stainless steel (STS), aluminum (Al), titanium (Ti), or the like. As an alternative to the example in which the plurality of cases form an inner space for accommodating components, the mobile terminal 100 may be configured such that one case forms the inner space. In this example, a mobile terminal 100 having a uni-body is formed so synthetic resin or metal extends from a side surface to a rear surface.

If desired, the mobile terminal 100 may include a waterproofing unit for preventing introduction of water into the terminal body. For example, the waterproofing unit may include a waterproofing member which is located between the window 151a and the front case 101, between the front case 101 and the rear case 102, or between the rear case 102 and the rear cover 103, to hermetically seal an inner space when those cases are coupled. The mobile terminal 100 may include the display unit 151, the audio output module, the proximity sensor 141, the illuminance sensor 142, the optical output module 154, the camera 121, the user input unit 123, the microphone 122 and the interface unit 160.

It will be described for the mobile terminal as shown in FIGS. 1B and 1C. The display unit 151, the first audio output module 152a, the proximity sensor 141, an illumination sensor 142, the optical output module 154, the first camera 121a and the first manipulation unit 123a are arranged in front surface of the terminal body, the second manipulation unit 123b, the microphone 122 and interface unit 160 are arranged in side surface of the terminal body, and the second audio output modules 152b and the second camera 121b are arranged in rear surface of the terminal body.

Alternative arrangements are possible and within the teachings of the instant disclosure. Some components may be omitted or rearranged. For example, the first manipulation unit 123a may be located on another surface of the terminal body, and the second audio output module 152b may be located on the side surface of the terminal body.

The display unit 151 is generally configured to output information processed in the mobile terminal 100. For example, the display unit 151 may display execution screen information of an application program executing at the mobile terminal 100 or user interface (UI) and graphic user interface (GUI) information in response to the execution screen information.

The display unit 151 outputs information processed in the mobile terminal 100. The display unit 151 may be implemented using one or more suitable display devices. Examples of such suitable display devices include a liquid crystal display (LCD), a thin film transistor-liquid crystal display (TFT-LCD), an organic light emitting diode (OLED), a flexible display, a 3-dimensional (3D) display, an e-ink display, and combinations thereof.

The display unit 151 may be implemented using two display devices, which can implement the same or different display technology. For instance, a plurality of the display units 151 may be arranged on one side, either spaced apart from each other, or these devices may be integrated, or these devices may be arranged on different surfaces.

The display unit 151 may also include a touch sensor which senses a touch input received at the display unit. When a touch is input to the display unit 151, the touch sensor may be configured to sense this touch and the controller 180, for example, may generate a control command or other signal corresponding to the touch. The content which is input in the touching manner may be a text or numerical value, or a menu item which can be indicated or designated in various modes.

The touch sensor may be configured in a form of a film having a touch pattern, disposed between the window 151a and a display on a rear surface of the window 151a, or a metal wire which is patterned directly on the rear surface of the window 151a. Alternatively, the touch sensor may be integrally formed with the display. For example, the touch sensor may be disposed on a substrate of the display or within the display.

The display unit 151 may also form a touch screen together with the touch sensor. Here, the touch screen may serve as the user input unit 123 (see FIG. 1A). Therefore, the touch screen may replace at least some of the functions of the first manipulation unit 123a. The first audio output module 152a may be implemented in the form of a speaker to output voice audio, alarm sounds, multimedia audio reproduction, and the like.

The window 151a of the display unit 151 will typically include an aperture to permit audio generated by the first audio output module 152a to pass. One alternative is to allow audio to be released along an assembly gap between the structural bodies (for example, a gap between the window 151a and the front case 101). In this instance, a hole independently formed to output audio sounds may not be seen or is otherwise hidden in terms of appearance, thereby further simplifying the appearance and manufacturing of the mobile terminal 100.

The optical output module 154 can be configured to output light for indicating an event generation. Examples of such events include a message reception, a call signal reception, a missed call, an alarm, a schedule notice, an email reception, information reception through an application, and the like. When a user has checked a generated event, the controller can control the optical output unit 154 to stop the light output.

The first camera 121a can process image frames such as still or moving images obtained by the image sensor in a capture mode or a video call mode. The processed image frames can then be displayed on the display unit 151 or stored in the memory 170.

The first and second manipulation units 123a and 123b are examples of the user input unit 123, which may be manipulated by a user to provide input to the mobile terminal 100. The first and second manipulation units 123a and 123b may also be commonly referred to as a manipulating portion, and may employ any tactile method that allows the user to perform manipulation such as touch, push, scroll, or the like. The first and second manipulation units 123a and 123b may also employ any non-tactile method that allows the user to perform manipulation such as proximity touch, hovering, or the like.

FIG. 1B illustrates the first manipulation unit 123a as a touch key, but possible alternatives include a mechanical key, a push key, a touch key, and combinations thereof. Input received at the first and second manipulation units 123a and 123b may be used in various ways. For example, the first manipulation unit 123a may be used by the user to provide an input to a menu, home key, cancel, search, or the like, and the second manipulation unit 123b may be used by the user to provide an input to control a volume level being output from the first or second audio output modules 152a or 152b, to switch to a touch recognition mode of the display unit 151, or the like.

As another example of the user input unit 123, a rear input unit may be located on the rear surface of the terminal body. The rear input unit can be manipulated by a user to provide input to the mobile terminal 100. The input may be used in a variety of different ways. For example, the rear input unit may be used by the user to provide an input for power on/off, start, end, scroll, control volume level being output from the first or second audio output modules 152a or 152b, switch to a touch recognition mode of the display unit 151, and the like. The rear input unit may be configured to permit touch input, a push input, or combinations thereof.

The rear input unit may be located to overlap the display unit 151 of the front side in a thickness direction of the terminal body. As one example, the rear input unit may be located on an upper end portion of the rear side of the terminal body such that a user can easily manipulate it using a forefinger when the user grabs the terminal body with one hand. Alternatively, the rear input unit can be positioned at most any location of the rear side of the terminal body.

Embodiments that include the rear input unit may implement some or all of the functionality of the first manipulation unit 123a in the rear input unit. As such, in situations where the first manipulation unit 123a is omitted from the front side, the display unit 151 can have a larger screen. As a further alternative, the mobile terminal 100 may include a finger scan sensor which scans a user's fingerprint. The controller 180 can then use fingerprint information sensed by the finger scan sensor as part of an authentication procedure. The finger scan sensor may also be installed in the display unit 151 or implemented in the user input unit 123.

The microphone 122 is shown located at an end of the mobile terminal 100, but other locations are possible. If desired, multiple microphones may be implemented, with such an arrangement permitting the receiving of stereo sounds.

The interface unit 160 may serve as a path allowing the mobile terminal 100 to interface with external devices. For example, the interface unit 160 may include one or more of a connection terminal for connecting to another device (for example, an earphone, an external speaker, or the like), a port for near field communication (for example, an Infrared Data Association (IrDA) port, a Bluetooth port, a wireless LAN port, and the like), or a power supply terminal for supplying power to the mobile terminal 100. The interface unit 160 may be implemented in the form of a socket for accommodating an external card, such as Subscriber Identification Module (SIM), User Identity Module (UIM), or a memory card for information storage.

The second camera 121b is shown located at the rear side of the terminal body and includes an image capturing direction that is substantially opposite to the image capturing direction of the first camera unit 121a. If desired, second camera 121a may alternatively be located at other locations, or made to be moveable, in order to have a different image capturing direction from that which is shown.

The second camera 121b can include a plurality of lenses arranged along at least one line. The plurality of lenses may also be arranged in a matrix configuration. The cameras may be referred to as an “array camera.” When the second camera 121b is implemented as an array camera, images may be captured in various manners using the plurality of lenses and images with better qualities.

A flash 124 is shown located adjacent to the second camera 121b. When an image of a subject is captured with the camera 121b, the flash 124 may illuminate the subject. The second audio output module 152b can be located on the terminal body. The second audio output module 152b may implement stereophonic sound functions in conjunction with the first audio output module 152a, and may be also used for implementing a speaker phone mode for call communication.

At least one antenna for wireless communication may be located on the terminal body. The antenna may be installed in the terminal body or formed by the case. For example, an antenna which configures a part of the broadcast receiving module 111 (see FIG. 1A) may be retractable into the terminal body. Alternatively, an antenna may be formed using a film attached to an inner surface of the rear cover 103, or a case that includes a conductive material.

A power supply unit 190 for supplying power to the mobile terminal 100 may include a battery 191, which is mounted in the terminal body or detachably coupled to an outside of the terminal body. The battery 191 may receive power via a power source cable connected to the interface unit 160. Also, the battery 191 can be recharged in a wireless manner using a wireless charger. Wireless charging may be implemented by magnetic induction or electromagnetic resonance.

The rear cover 103 is shown coupled to the rear case 102 for shielding the battery 191, to prevent separation of the battery 191, and to protect the battery 191 from an external impact or from foreign material. When the battery 191 is detachable from the terminal body, the rear case 103 may be detachably coupled to the rear case 102.

An accessory for protecting an appearance or assisting or extending the functions of the mobile terminal 100 can also be provided on the mobile terminal 100. As one example of an accessory, a cover or pouch for covering or accommodating at least one surface of the mobile terminal 100 may be provided. The cover or pouch may cooperate with the display unit 151 to extend the function of the mobile terminal 100. Another example of the accessory is a touch pen for assisting or extending a touch input to a touch screen.

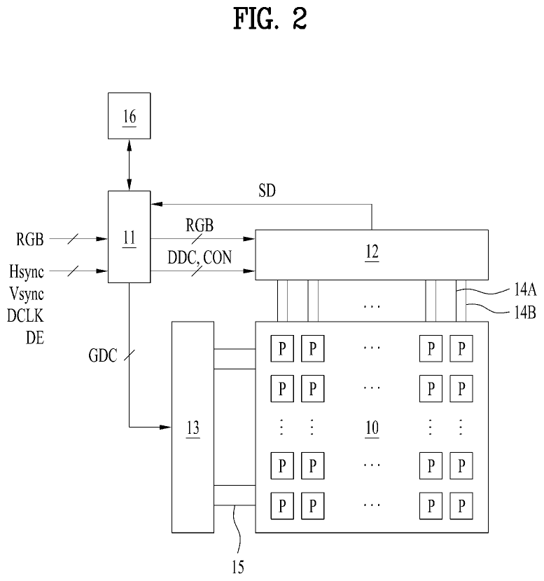

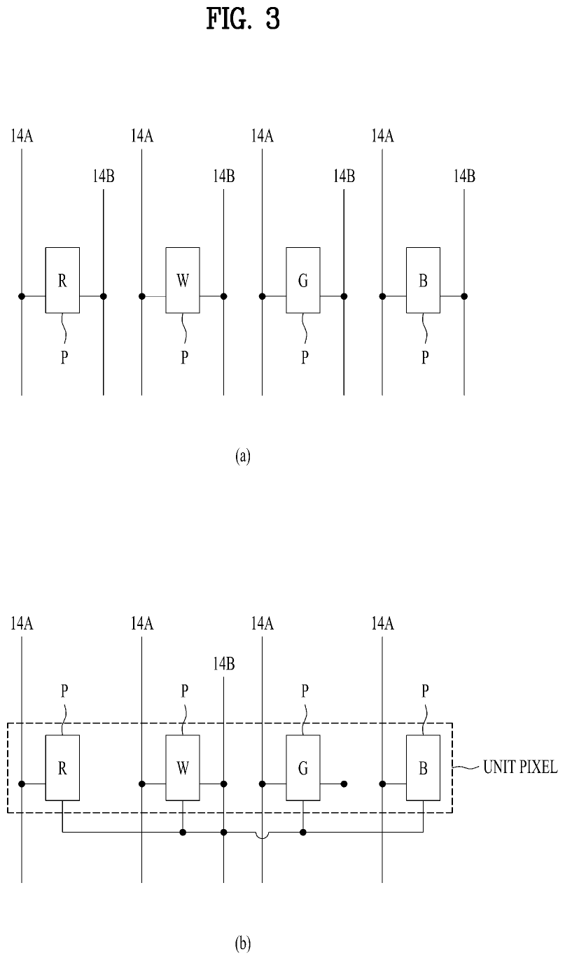

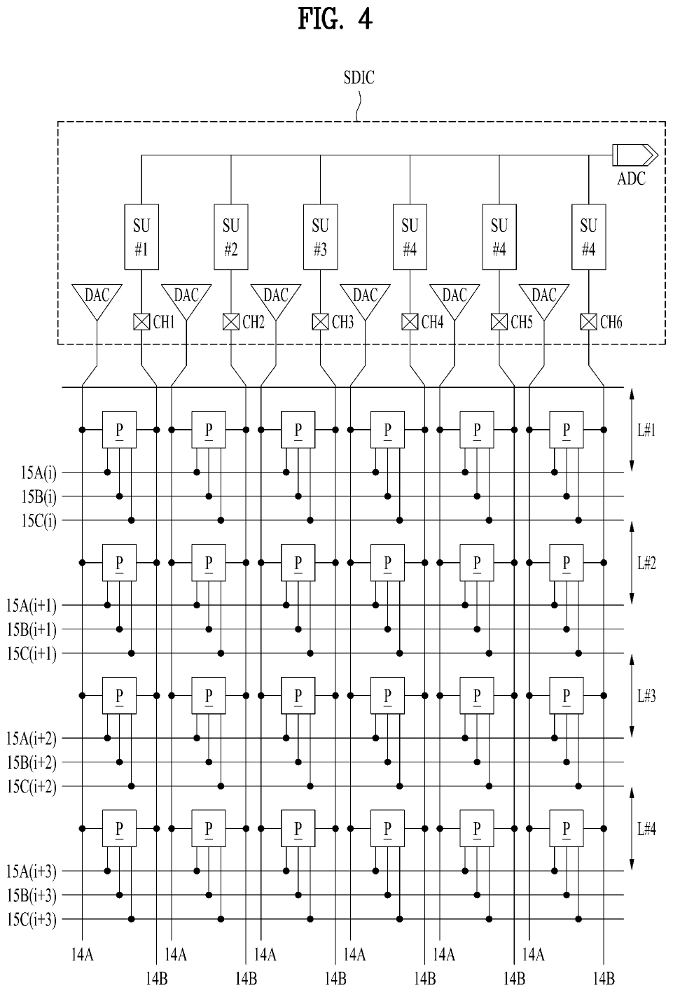

FIG. 2 illustrates an OLED display device in accordance with one embodiment of the present disclosure which includes the sensing unit, FIG. 3 is a diagram illustrating one example of connection between a sensing line and a pixel, and FIG. 4 is a diagram illustrating one example of a pixel array and a data driver IC. Referring to FIGS. 2 through 4, the OLED display device in accordance with the embodiment includes a display panel 10; a timing controller 11; a data drive circuit 12; a gate drive circuit 13; and a memory 16.

On the display panel 10 are aligned a plurality of data lines and sensing lines 14A and 14B and a plurality of gate lines 15 that are crossing each other. Pixels (P) are aligned in the crossing arears, respectively, in a matrix. The pixels (P) may include R-pixels for displaying red, W-pixels for displaying white, G-pixels for displaying greed and B-pixels for displaying blue which are neighboring side by side. Each of the pixels (P) is linked to one of the data lines 14A, one of the sensing lines 14B and one of the gate lines 15. Each pixel (P) is electrically connected to the data line 14A in response to the gate pulse input via the gate line 15, and then it receives a data voltage from the data line 14A and outputs a sensing signal via the sensing line 14B.

The sensing line 14B may be independently linked to each of the neighboring pixels side by side as shown in FIG. 3(a). For example, each of the R, W, G and B pixels that are neighboring horizontally may be linked to a different sensing line. Meanwhile, the sensing line 14B may be linked to at least two or more pixels that are neighboring horizontally as shown in FIG. 3(b). For example, the R, W, G and B pixels that are neighboring horizontally may share the same sensing line. The sensing line may be assigned for each one unit pixel (that includes an R pixel, a W pixel, a G pixel and a B pixel).

Each of the pixels (P) is supplied a high potential drive voltage (ELVDD) and a low potential drive voltage (ELVSS) from the power supply unit. The pixel (P) may include OLED, a drive TFT, first and second switch TFT and a storage capacitor. The TFTs of the pixel (P) may be realized as p-types or n-types. A semiconductor layer of the TFTs may include amorphous silicon, polysilicon or oxide.

Each of the pixels (P) may be actuated differently when driven to realize an image and when driven to acquire a sensing value. The sensing drive may be performed for a preset time period before the normal drive or a vertical blank period during the normal drive.

The normal drive may be performed by one actuation of the data drive circuit 12 and the gate drive circuit 13 under the control of the timing controller 11. The sensing drive may be performed by another actuation of the data drive circuit 12 and the gate drive circuit 13 under the control of the timing controller 11. The timing controller 11 may perform compensation data deriving for compensating a deviation based on the result of the sensing and digital video data modulation, using the derived compensation data.

The data drive circuit 12 includes at least one data drive IC (Integrated Circuit) (SDIC). The data drive IC (SDIC) includes a plurality of digital-analog converters (hereinafter, DACs) connected to each data line 14A; and a plurality of sensing unit (SU#1 ˜SU#6) connected to the sensing lines 14B via sensing channels (CH1 ˜ CHn).

DAC of the data drive IC (SDIC) converts digital video data (RGB) into a data voltage for realizing an image according to a data timing signal (DDC) applied from the timing controller 11 during the normal drive and supplies the converted data voltage to the data lines 14A. Meanwhile, DAC of the data drive IC (SDIC) generates a data voltage for sensing according to a data timing control signal (DDC) applied from the timing controller 11 during the sensing drive and supplies the generated sensing data voltage to the data lines 14A.

Each of the sensing units (SU#1˜#6) provided in the data drive IC (SDIC) may be configured to sense current information of a sensing object pixel (P) (that is the amount of the electric charge accumulating in an OLED parasitic capacitor in response to a drive current). Each of the sensing units (SU#1˜#6) may be realized to include a current integrator or realized as a current comparer. When each of the sensing units (SU#1˜#6) is realized to include the current integrator, the data drive IC (SDIC) may further include an analog-digital converter (hereinafter, ADC) connected to output ends of the sensing units (SU#1˜#6). The data drive IC (SDIC) is configured to digitally process an analog sensing value and transmit the digitalized sensing value to the timing controller 11.

The gate drive circuit 13 generates a gate pulse for displaying an image based on the gate control signal (GDC) in the normal drive and supplies the generated gate pulse for the image displaying to the gate lines 15 sequentially (e.g., L#1, L#2, . . . ) after that. The gate drive circuit 13 generates a gate pulse for sensing based on a gate control signal (GDC) in the sensing drive and then sequentially supplies the generated gate pulse for sensing to the gate lines 15 (e.g., L#1, L#2, . . . ). The gate pulse for sensing has a wide on-pulse interval, compared with the gate pulse for image displaying. The on-pulse interval of the gate pulse for the sensing is corresponding to a first line sensing on-time. In this instance, the first line sensing on-time means the scan time allotted for simultaneously sensing the pixels of the first row pixel line (L#1, L#2, . . . ).

The gate pulse may include a scan control signal (SCAN), a light-emitting control signal (EM) and a sensing control signal (SENSE). The scan control signal (SCAN), the light-emitting control signal (EM) and the sensing control signal (SENSE) may be realized as the same signals or different type signals. When SCAN and SENSE are realized as the same signals, SCAN and SENSE may be applied to each of the pixels (P) via the same gate line 15 as the identical single signal and it is effective in reducing the number of signal wires. In contrast, when SCAN and SEN are realized as different signals, SCAN, EM and SENSE may be applied to each of the pixels (P) via different gate lines, respectively.

The timing controller 11 may be implemented to generate a data control signal (DDC) for controlling the actuation timing of the data drive circuit 12, a gate control signal (GDC) for controlling the actuation timing of the gate drive circuit 13 based on timing signals such as a vertical synchronization signal (Vsync), a horizontal synchronization signal (Hsync), a dot clock signal (DCLK), a data enable signal (DE) and the like. The timing controller 11 distinguishes the normal drive and the sensing drive from each other based on a predetermined reference signal (e.g., the drive power enable signal, the vertical synchronization signal, the data enable signal and the like and generates a corresponding data control signal (DDC) and a corresponding gate control signal (GDC) to the normal drive and the sensing drive.

Moreover, the timing controller 11 may further generate related switching control signals with actuating internal switches of the sensing units (SU#1˜#6) according to the normal drive and the sensing drive. The timing controller 11 may transmit corresponding digital data to the data voltage for sensing in the sensing drive to the data drive circuit 12. The timing controller 11 may detect OLED degradation of each pixel (P) based on the digital sensing value (SD) transmitted from the data drive circuit 12 during the sensing drive and store the compensation data capable of compensating degradation deviations among the pixels (P) in the memory 16.

The timing controller 11 may modulate the compensation data stored in the memory 16 into digital video data (RGB) for realizing an image in the normal drive and then transmit the modulated data to the data drive circuit 12.

The mobile terminal in accordance with the present disclosure adopts a current sensing method to reduce the sensing time and the sensing accuracy by realizing low-currents and high-speed sensing. As one example of the current sensing method, at least one sensing unit is installed in the data drive circuit of the mobile terminal. When a drive current flows to an OLED of a sensing object pixel, the sensing unit is configured to sense the amount of the electric charge accumulating in a parasitic capacitor of OLED.

In addition, the present disclosure is not limited thereto and a voltage sensing method can be adopted to sense a degradation degree of an OLED. After an OLED anode voltage is stored in a parasitic capacitor of the sensing line, the sensing unit can sense the stored voltage.

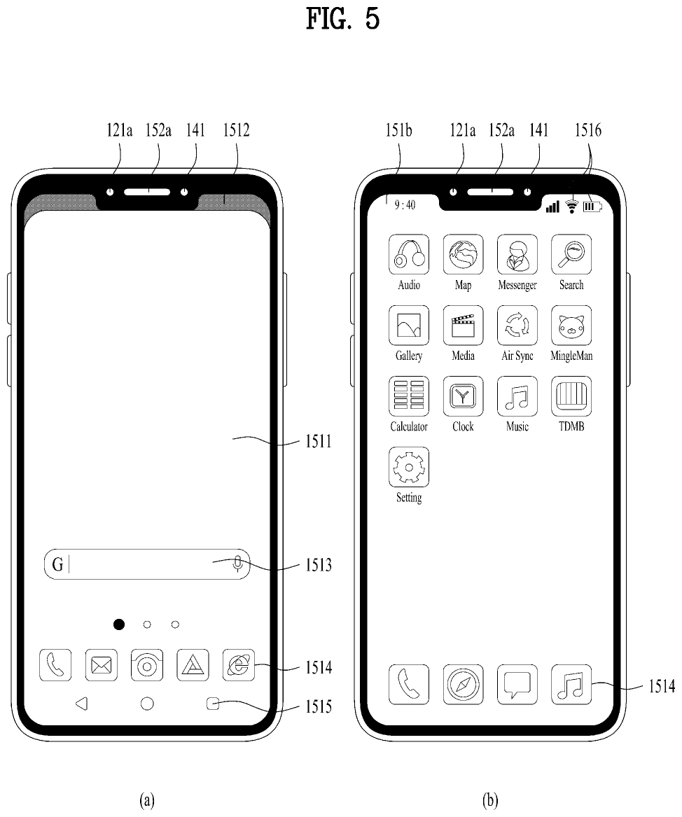

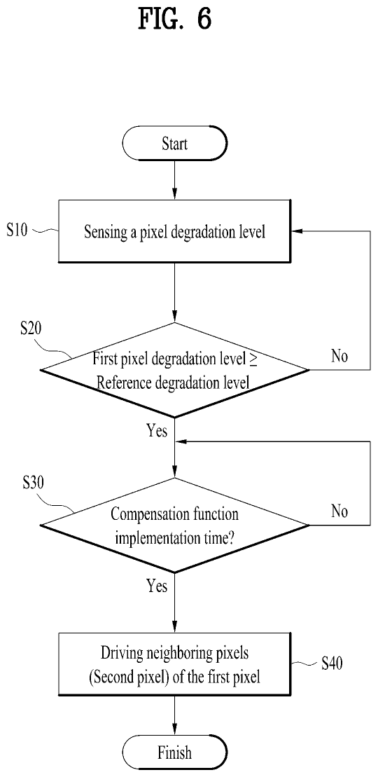

Next, FIG. 5 is a diagram illustrating one example of a screen that is output on the display unit 151 of the present disclosure. Referring to FIG. 5, the area in which a degradation deviation occurs will be described. As the display unit 151 is expanded, a button located in a lower end area of the front surface of the mobile terminal 100 is omitted and a virtual key 1515 is displayed in a lower area of the display unit 151. As occasion demands, the lower virtual key 1515 may be inactivated or displayed in another location when the mobile terminal 100 is arranged in a horizontal direction. However, the virtual key 1515 may be output at the same location of the display unit 151 most of time as shown in FIG. 5(a).

Even when a page of the screen having an icon 1514 located in a lower end area of the screen shown in FIGS. 5(a) and (b) is changed, an icon 1514 may not be changed but output at the same location for a while. A window box 1513 shown in FIG. 5(a) or a current-state icon 1516 displayed on an upper end area shown in FIG. 5(b) may be also output at the same location for a while.

The image or icon output at the same location for a preset time period or more is called the fixed object. The OLED arranged in the location of the fixed object may be continuously driven as the same color and brightness such that there may be a problem of degradation in an OLED. When the current color or image is changed, each of the pixels drives the three colors selectively and it has no severe degradation. However, to output the fixed object, one or more specific pixels are consistently driven to emit the same color and bright. Accordingly, there may be a degradation deviation between the specific pixels driven to output the fixed object and the other neighboring pixels only to cause a residual image.

Rather than the above-noted example, even when the display unit is used as a navigation device in driving a vehicle, a navigation button is the fixed object turned on continuously and a life span of the display unit provided in the mobile terminal is likely to be shortened disadvantageously because of a degradation deviation between the pixel outputting the fixed object and the neighboring pixels.

The display unit 151 is expanded to the other upper end area except the area of the components located in the upper end area of the front surface including the audio output unit 152a, the camera 121a, the proximity sensor 141, only to further have a second area 1512. In the second area 1512, the current-state display icon 1516 displaying a battery level, a current communication state and the like may be displayed (see FIG. 5(b)).

For a user who will not prefer a display design having unevenness on the upper end, the second area 1512 may be used in a turned-off state as shown in FIG. 5(b). In other words, only the pixels of the first area 1511 are driven but no pixels of the second area 1512 are driven, so as to look like a conventional rectangular-shaped display unit 151. In this instance, the pixels of the second area 1512 are not deteriorated but only the pixels of the first area 1511 are deteriorated relatively. Accordingly, a boundary between the first area 1511 and the second area 1512 remains as a residual image disadvantageously.

The degradation of the OLED is caused while specific pixels emit relatively more light than the other neighboring pixels to output the same image and the residual image may be caused by a deterioration difference between the specific pixels and the neighboring pixels.

To solve the disadvantage, the circuit of the deteriorated OLED pixel is configured to compensate the degradation deviation and apply more voltage or currents to the deteriorated OLED so as to prevent the brightness of the specific pixels from becoming deteriorated. Such a compensating method is intuitive and has an advantage that only specific pixels are controlled to compensate the degradation deviation, without auxiliary algorithms. However, if the OLED degradation of the specific pixels becomes more serious even to the final level, the specific pixels may not recover and the life span of the display unit may be shortened.

When using only the method of controlling the voltage of each pixel, it might be difficult to tune a difference between the pixel and the neighboring pixels and insufficient to solve the problem of the residual image. Accordingly, a compensation function can be implemented to solve the problem of the residual image caused by the OLED degradation.

FIG. 6 is a flow chart illustrating the compensation function. A degradation level of each pixel is sensed (S10). The voltage of each pixel is sensed to sense the degradation level and a pixel of which a degradation level is a reference degradation level or more may be judged as the first deteriorated pixel (1511, 1513, 1514, 1515, 1516) (S20). Alternatively, the fixed object of which the same image is output for a preset time period is identified based on the image information provided to the display unit 151. When the cumulative time while the fixed object is output is a reference time value or more, the pixel for outputting the fixed object is judged as the first pixel (1511, 1513, 1514, 1515, 1516) (S10, S20).

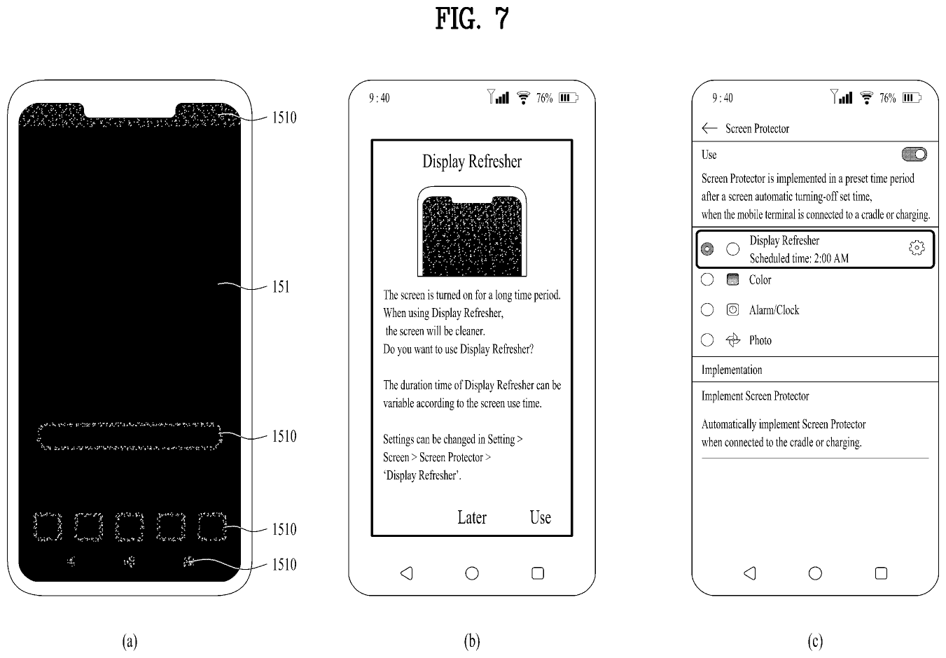

A second pixel 1510 (see FIG. 7) arranged adjacent to the first deteriorated pixel (1511, 1513, 1514, 1515, 1516) is driven to implement the compensation function (S40). In more detail, FIG. 7 is a diagram to describe the compensation function of the mobile terminal 100. As shown in FIG. 7(a), the neighboring pixel 1510 of the fixed object such as the virtual key 1515, the icon 1514 or the search box 1513 that is located in the lower area of the display unit 151 are driven. A degradation deviation between the deteriorated or degradation-expected pixel and the neighboring pixel 1510 is reduced by driving the pixels so as to prevent a residual image remaining on the display unit 151 that might be caused by the fixed object.

The compensation function can be implemented while the display unit 151 of the mobile terminal 100 is not used. For example, the compensation function can be implemented late at night or during the charging, in other words, when it is determined that the user is not using the display unit.

When the second pixel 1510 is turned on bright at the same time, the brightness is likely to dazzle the user's eyes even late at night or during the charging. Accordingly, the second pixel 1510 can be driven alternately or a specific image may be realized and output for an esthetic function.

The compensation function can be controlled to be implemented during the night or charging as function preference. When the fixed object is output for a preset time period or more or a degradation level of a specific pixel is a reference value or more, an alarm message is provided to the user to recommend the implementation of the compensation function as shown in FIG. 7(b) so as to induce the implementation of the compensation function. As shown in FIG. 7(c), the user can set the compensation function to be implemented from a settings menu.

The compensation function mentioned above can be implemented while the display unit 151 is not used. However, the compensation function for preventing the degradation of a specific pixel can be implemented even when the display unit 151 is used. The location of the fixed object is periodically changed a little in a state where the display unit 151 is actuated so as to prevent the residual image.

As described above, the mobile terminal 100 according to the embodiments of the present disclosure can prevent the residual image caused by the OLED degradation and expand the life span of the display unit 151. Furthermore, the problem of the residual image remaining on the screen can be prevented by controlling the neighboring pixels of the deteriorated pixel as well as controlling the degradation of the deteriorated pixel in the circuit.

As the present features may be embodied in several forms without departing from the characteristics thereof, it should also be understood that the above-described embodiments are not limited by any of the details of the foregoing description, unless otherwise specified, but rather should be considered broadly within its scope as defined in the appended claims, and therefore all changes and modifications that fall within the metes and bounds of the claims, or equivalents of such metes and bounds, are therefore intended to be embraced by the appended claims.

What is claimed is:

1. A mobile terminal comprising:
a display unit including a plurality of pixels aligned in a matrix; and
a controller configured to:
display a screen on the display unit,
display a fixed object at a specific location on the screen for a preset time period or more, and
drive an adjacent pixel located adjacent to the fixed object at a compensated level while pixels for the fixed object are not driven.

2. The mobile terminal of claim 1, wherein the pixel located adjacent to the fixed object includes a plurality of adjacent pixels surrounding the pixels of the fixed object.

3. The mobile terminal of claim 1, wherein the controller is further configured to gradually reduce drive times or frequencies of pixels adjacent to the pixels of the fixed object along a direction farther from a neighboring area of the fixed object.

4. The mobile terminal of claim 1, wherein the fixed object comprises at least one of a fixed icon, a menu button, a former page button, a home button, a search box and a current-state display icon.

5. The mobile terminal of claim 1, wherein the controller is further configured to set a time of driving the adjacent pixel at the compensated level in proportion to a time period while the fixed object is displayed on the display unit.

6. The mobile terminal of claim 1, wherein the screen includes a first area outputting an image and a second area not outputting an image, and
wherein the controller is further configured to drive a pixel of an area of the second area that is near the first area at the compensated level.

7. The mobile terminal of claim 1, wherein the plurality of the pixels comprises a sensing transistor configured to sense a variation of a voltage or current value applied to each of the pixels, and
wherein the controller is further configured to compensate a voltage value applied to the adjacent pixel of which the voltage or current value is varied based on a result of the sensing performed by the sensing transistor and control the adjacent pixel having the compensated voltage value to emit light having a same brightness as neighboring pixels.

8. The mobile terminal of claim 1, wherein the plurality of the pixels comprises a sensing transistor configured to configured to sense a variation of a voltage or current value applied to each of the pixels, and
wherein the controller is further configured to compensate neighboring pixels of the adjacent pixel of which of which a voltage or current value is varied based on a result of the sensing performed by the sensing transistor.

9. The mobile terminal of claim 1, wherein the controller is further configured to compensate the adjacent pixel based on image information of the fixed object.

10. The mobile terminal of claim 1, wherein the controller includes a display drive IC coupled to one side of the display unit.

11. The mobile terminal of claim 1, wherein the controller is further configured to:
display a compensation level screen for setting an option to compensate the level of the adjacent pixel.

12. The mobile terminal of claim 11, wherein the compensation level screen includes an option for setting a duration time of compensating the adjacent pixel at the compensation level.

13. The mobile terminal of claim 11, wherein the compensation level screen includes an option for turning on or off the compensation of the adjacent pixel at the compensated level.

14. The mobile terminal of claim 11, wherein the compensation level screen is displayed within a settings menu of the mobile terminal.

15. The mobile terminal of claim 11, wherein the compensation level screen includes an option for setting a specific time in a day for compensating the adjacent pixel at the compensated level.

16. The mobile terminal of claim 1, wherein the controller is further configured to compensate the adjacent pixel at the compensated level when the display is turned off

17. The mobile terminal of claim 1, wherein the controller is further configured to compensate the adjacent pixel at the compensated level when the mobile terminal is connected to a cradle for charging the mobile terminal.

18. A method of controlling a mobile terminal, the method comprising:
displaying a screen on a display unit of the mobile terminal;
displaying a fixed object at a specific location on the screen for a preset time period or more on the display unit; and
driving, via a controller of the mobile terminal, an adjacent pixel located adjacent to the fixed object at a compensated level while pixels for the fixed object are not driven.

19. The method of claim 18, wherein the pixel located adjacent to the fixed object includes a plurality of adjacent pixels surrounding the pixels of the fixed object.

20. The method of claim 19, further comprising:
gradually reducing, via the controller, drive times or frequencies of pixels adjacent to the pixels of the fixed object along a direction farther from a neighboring area of the fixed object.
